(19) United States
(12) Patent Application Publication
(10) Pub. No.: US 2007/0038964 A1
(43) Pub. Date: Feb. 15, 2007

(54) SYSTEM AND METHOD FOR EXTRACTING MATERIAL DIFFERENCES BETWEEN DIFFERENT CIRCUIT BOARD DESIGN DIAGRAMS

(76) Inventors: Ge-Xin Zeng, Shenzhen (CN); Chang-Wen Fu, Shenzhen (CN); De-Sheng Qiu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,970

(22) Filed: Jun. 1, 2006

(30) Foreign Application Priority Data
Jul. 29, 2005 (CN) 200510036283.6

(51) Int. Cl. G06F 17/50

(52) U.S. Cl. 716/1

(57) ABSTRACT

A system is provided for extracting material changes in different design diagrams of a motherboard. The system includes: an extracting module for extracting a first raw BOM from a first circuit design diagram of the motherboard, and for extracting a second raw BOM from a second circuit design diagram of the motherboard, wherein the second circuit design diagram is partially identical to the first circuit design diagram; a converting module for converting the first raw BOM to a first standard BOM, and for converting the second raw BOM to a second standard BOM; a integrity checking module for determining whether data in the two standard BOMs are error free; and an comparing module for comparing the two standard BOMs to extract material changes. A related method is also disclosed.

### FIELD OF THE INVENTION

The present invention relates to a system and method for extracting material differences in different circuit board design diagrams.

### DESCRIPTION OF RELATED ART

When a design of a circuit board is upgraded, both design and manufacturing production houses need to be informed of any material changes between an old model and an upgraded model. This is usually done by manually comparing the previous circuit board design diagram against the upgraded circuit board design diagram section by section, jotting down differences along the way. If a component in a section is removed, or if the section introduces a new component, or even if an attribute of the component is changed such as its material property, supplier, etc., the changes needs to be recorded. In fact, every changed instance on a sophistically assembled circuit board with thousands of components attributes needs to be recorded. Thus manually recording of changes between a pervious circuit board and its upgraded model is a very tedious job with a low efficiency and a high error rate.

China App. Pub. No.-1444161 named “method for analyzing data in a bill of material (BOM)” and published on Sep. 24, 2003 disclosed a method for analyzing data in a BOM to provide referential information for purchasing and production. However, the above method cannot be applied to compare information between two BOMs, such as to compare the BOM of a previous circuit board design diagram with the BOM of an upgraded circuit board design diagram.

What is needed, therefore, is a system and method for extracting material differences in different circuit board design diagrams resulting in higher work efficiency and accuracy, so as to assist circuit board designers and producers.

### SUMMARY OF INVENTION

A system for extracting material differences between different circuit board design diagrams in accordance with a preferred embodiment is provided. The system includes: an extracting module used for extracting a first raw BOM from a first circuit design diagram of a circuit board, and extracting a second raw BOM from a second circuit design diagram of the circuit board, wherein the second circuit design diagram is partially identical to the first circuit design diagram; a converting module for converting the first raw BOM to a first standard BOM, and converting the second raw BOM to a second standard BOM; an integrity checking module for determining whether data in the two standard BOMs are error free; and a comparing module for comparing the two standard BOMs to extract material differences in the two design diagrams of the circuit board.

Another preferred embodiment provides a method for extracting material differences between different circuit board design diagrams. The method includes the steps: (a) extracting a first raw BOM from a first circuit design diagram of a circuit board, and extracting a second raw BOM from a second circuit design diagram of the circuit board, wherein the second circuit design diagram is partially identical to the first circuit design diagram; (b) converting the first raw BOM to a first standard BOM, and converting the second raw BOM to a second standard BOM; (c) determining whether data in the two standard BOMs are error free; and (d) comparing the two standard BOMs to extract material differences in the two circuit design diagrams of the circuit board, if the data in the two standard BOMs are error free.

Other advantages and novel features of the embodiments will be drawn from the following detailed description with reference to the attached drawings, in that:

### BRIEF DESCRIPTION OF DRAWINGS

FIG. 1 is a schematic diagram illustrating a system for extracting material differences between different circuit board design diagrams according to a preferred embodiment;

FIG. 2 is a flowchart of a preferred method for extracting material differences between different circuit board design diagrams by utilizing the system of FIG. 1;

FIG. 3 is a typical titled empty list in a standard BOM; and

FIG. 4 is another titled empty list for material changes in different design diagrams of a circuit board.

### DETAILED DESCRIPTION

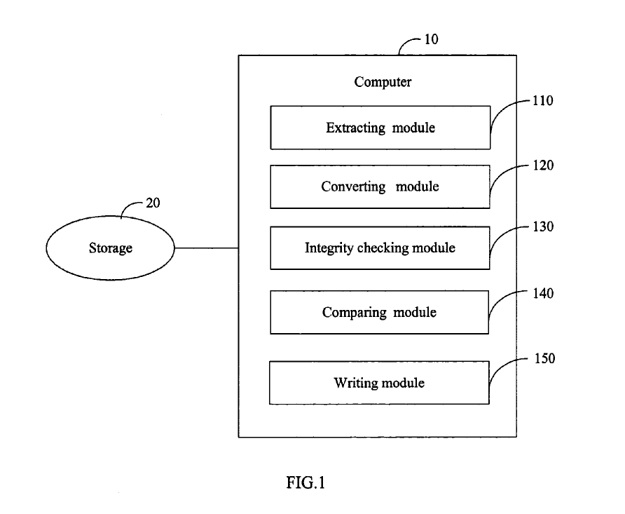

FIG. 1 is a schematic diagram illustrating a system for extracting material differences between different circuit board design diagrams (hereinafter, “the system”) according to a preferred embodiment. The system typically includes a computer 10 and a storage 20. The storage 20 is connected to the computer 10, and is used for storing information generated by utilizing the system, such as circuit design diagrams of various circuit boards, raw bills of material (BOMs) of circuit boards, standard BOMs of circuit boards, and so on. The computer 10 includes a plurality of units known in the art, such as a central processing unit (CPU) and a memory (not shown), for extracting material changes in different design diagrams of a circuit board. In the preferred embodiment, the circuit board is a motherboard. Additionally, the computer 10 further includes: an extracting module 110, a converting module 120, an integrity checking module 130, a comparing module 140, and a writing module 150. The extracting module 110 is used for extracting the attributes of components of a motherboard circuit design diagram stored in the storage 20. In the preferred embodiment, the extracted data from a previous and a similar circuit design diagram of the motherboard are separately stored into two Excel spreadsheets as two raw BOM files. The converting module 120 is used for converting the first raw BOM file into a first standard BOM file format, and converting the second raw BOM file into a second standard BOM file format that corresponds to the previous motherboard circuit design model and it's similar model respectively. The integrity checking module 130 is used for determining whether data converted from the excel format to the standard BOM format have been successfully done such that no errors exists. The comparing module 140 is used for comparing the two standard BOM files to extract material changes in the two circuit design diagrams. The writing module 150 is used for writing the material changes into a list in the second standard BOM file.

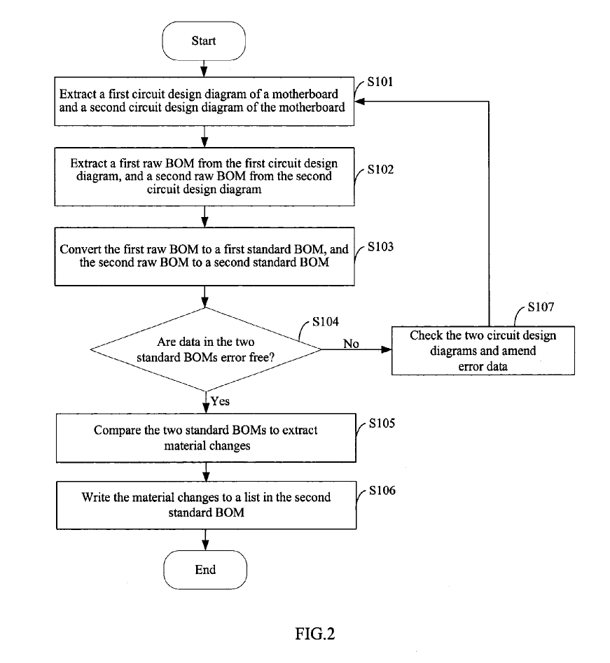

FIG. 2 is a flowchart of a preferred method for extracting material differences between different circuit board design diagrams by utilizing the system of FIG. 1. In step S101, the extracting module 110 extracts a first circuit design diagram of a motherboard from the storage 20, and extracts a similar circuit design diagram of the motherboard from the storage 20. In step S102, the extracting module 110 extracts a first raw BOM file from the first circuit design diagram, and extracts a second raw BOM file from the similar circuit design diagram; one being the previous model, and the other may be the upgraded model, into two separate excel spreadsheets. In step S103, the converting module 120 converts the two raw BOM files into the two corresponding standard BOM format files.

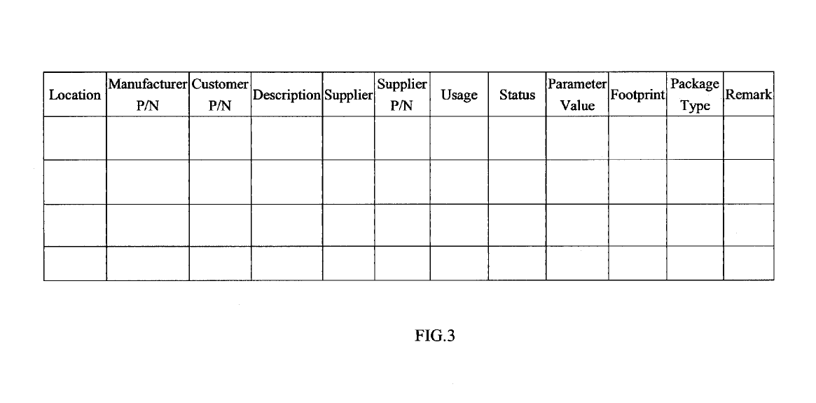

Each standard BOM file includes information describing parts stored in different lists in the BOM file. Since the motherboard may be single sided or double sided, the transformed standard BOM files may be different in some aspects. For example, if the motherboard is single sided, each transformed standard BOM file may have four lists as: a first list named SMD (short for surface mount device) about surface mount parts, a second list named PTH (short for plated-through-hole) about through-hole parts, a third list named PACKING about packing parts, and a fourth list named DUMMY about non-functional parts. If the motherboard is double sided, each transformed standard BOM file may have five lists as: a first list named SMD TOP about surface mount devices on a top side of the motherboard, a second list named SMD BOTTOM about surface mount devices on a bottom side of the motherboard, and a third list named PTH, a fourth list named PACKING, and a fifth list named DUMMY. Each list in the standard BOM files includes items illustrated in FIG. 3.

In step S104, the integrity checking module 130 checks the data integrity of the standard BOM format files. If the data fails the integrity check, the procedure goes to step S107 described later.

If the data in the two standard BOM format files pass the data integrity check, in step S105, the comparing module 140 compares each list in the first standard BOM file with each corresponding list in the second standard BOM file, so as to extract all material changes in the two design diagrams of the motherboard. For example, whether a part on a location is removed, or the location increases a new part, or the material property of the part on the location has been changed, such as the kind of the material, the quality of the material, the supplier of the material, and so on.

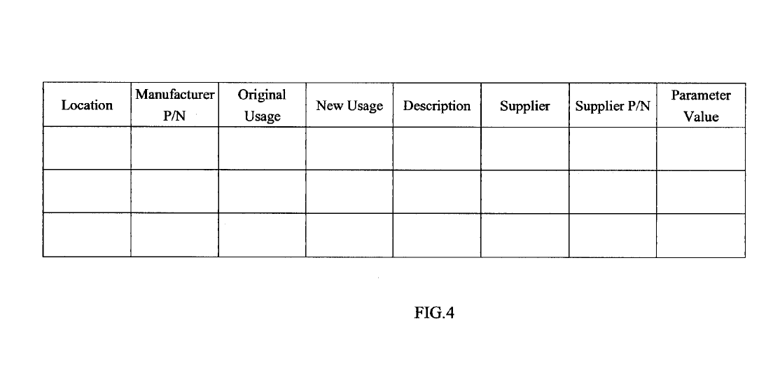

In step S106, the writing module writes all material changes into a list in the second standard BOM file, which may include items as: LocationManufacturer P/N\Original\UsageNew Usage\Description\Supplier\Supplier P/N\Parameter Value(illustrated in FIG. 4).

In step S107, if the integrity checking module 130 determines that the data in the two standard BOM files do not satisfy the motherboard design requirements, the integrity checking module 130 checks the two circuit design diagrams to find error data, and amends the error data. Hereinafter, the procedure returns to step S101 described above.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for extracting material differences between different circuit board design diagrams, the system comprising:
an extracting module for extracting a first raw bill of material (BOM) from a first circuit design diagram of a circuit board, and extracting a second raw BOM from a second circuit design diagram of the circuit board, wherein the second circuit design diagram is partially identical to the first circuit design diagram;
a converting module for converting the first raw BOM to a first standard BOM, and converting the second raw BOM to a second standard BOM;
an integrity checking module for determining whether data in the two standard BOMs are error free; and
a comparing module for comparing the two standard BOMs to extract material differences in the two design diagrams of the circuit board.

2. The system according to claim 1, wherein the extracting module is further used for extracting the first circuit design diagram and the second circuit design diagram of the circuit board from a storage communicating with the system.

3. The system according to claim 1 further comprising a writing module for writing the material differences into the second standard BOM.

4. The system according to claim 1, wherein the integrity checking module is further used for checking the two circuit design diagrams and amending error data in the two circuit design diagrams.

5. A computer-based method for extracting material differences between different circuit board design diagrams, comprising the steps of:
extracting a first raw BOM from a first circuit design diagram of a circuit board, and converting a second raw BOM from a second circuit design diagram of the circuit board, wherein the second circuit design diagram is partially identical to the first circuit design diagram;
converting the first raw BOM to a first standard BOM, and converting the second raw BOM to a second standard BOM;
determining whether data in the two standard BOMs satisfy design requirements of the circuit board; and
comparing the two standard BOMs to extract material differences of the two design diagrams of the circuit board, if the data in the two standard BOMs are error free.

6. The method according to claim 5, further comprising the step of:
extracting the first circuit design diagram and the second circuit design diagram of the circuit board from a storage.

7. The method according to claim 5, further comprising the step of:
writing the material differences into a list in the second standard BOM.

8. The method according to claim 5, further comprising the step of:
checking the two circuit design diagrams and amending error data in the two circuit design diagrams.
